(19) United States
(12) Patent Application Publication
(10) Pub. No.: US 2001/0034808 A1
(43) Pub. Date: Oct. 25, 2001

(54) CACHE MEMORY DEVICE AND INFORMATION PROCESSING SYSTEM

(76) Inventors: ATSUSHI NAKAJIMA, HADANO-SHI (JP); MASABUMI SHIBATA, KAWASAKI-SHI (JP)

Correspondence Address: FAY SHARPE BEALL FAGAN MINNICH & MCKEE, 104 HUME AVENUE, ALEXANDRIA, VA, 22301

(21) Appl. No.: 09/182,046

(22) PCT Filed: Jul. 19, 1996
(86) PCT No.: PCT/JP96/02020

§ 371 Date: None

(51) Int. Cl. G06F 12/08

(52) U.S. Cl. 711/3; 711/128; 711/133; 711/5

(57) ABSTRACT

A highly associative cache memory device is arranged to use as a data memory a memory like a SDRAM to be accessed by a row access and a column access and locate the data of all the ways of the same set number on the same row. A cache control circuit 5 executes the row access to the data memory before fixing a cache hit determination. If a cache is hit, the column access is executed by the hit way number. If a cache-miss takes place and thus the write back is necessary, the column access is executed by using the replace way number. If a cache-miss takes place and thus no write back is necessary, the column access is interrupted. These operations make it possible to reduce an access latency and a busy time of a memory bank as saving the pins of an LSI being inputted with data if an outside SDRAM chip is used for the data memory. If the cache miss takes place, the row access is effective for reading the data to be written back to the cache. This prevents the using efficiency of the data memory bank from being lowered.

### TECHNICAL FIELD

1. Field of Industrial Application

The present invention relates to a cache memory device included in an information processing system, and more particularly to the cache memory device which uses a DRAM including an SDRAM (Synchronous Dynamic Random Access Memory) as its data memory and the information processing system provided with the cache memory device.

2. Background Art

In order to ameliorate processing performance of a processor, in general, a computer system is arranged to provide a cache memory composed of a small-volume and quick memory between a fast processor and a main storage unit that operates at a slower rate than the processor. In this arrangement, part of data is loaded from the main storage unit into the cache memory so that the processor can access the cache memory instead of the main storage unit. This results in making the latency of the data from the main storage unit to the processor shorter. In general, the goal of designing the cache memory is to improve a hit rate and shorten an access latency.

In order to improve the hit rate, the cache memory is required to increase its volume and enhance associativity. The implementation of them is a trade-off for the access latency. To shorten the access latency, the SRAM element has been conventionally used for the data memory. The volume of the SRAM element is limited in respect of a degree of integration. By applying a DRAM, instead, such as a synchronous DRAM (referred to as an SDRAM) to the data memory, the volume of the data memory may be made larger than when using the SRAM as the data memory. However, the application of the DRAM may lead to increasing the latency and causes a problem of a busy time of a memory bank. In particular, the latency of the row access is comparatively long. As disclosed in JP-A-62-82592, a system for concealing the latency of the row access by making use of a page mode function has been proposed for the memory system composed of the DRAMs.

On the other hand, in case of implementing the data memory with outside memory chips, the trade-off for increase in the number of pins of an LSI being inputted with data is loss of the association of the cache memory. In the article described in pages 97 to 108 of Nikkei Electronics, Jan. 30, 1995 (No. 627), in a two-way set associative cache composed of the synchronous SRAM, a system is disclosed for saving the pins of the LSI by reading only data in one way at a time.

It is an object of the present invention to provide a high level of set associative cache memory device which is arranged to shorten the access latency and to decrease the busy time of the memory bank as saving the pins of the LSI for being inputted with data if an outside SRAM chip is used in the data memory.

### DISCLOSURE OF INVENTION

### PROBLEM TO BE SOLVED BY THE INVENTION

In carrying out the object, according to an aspect of the invention, a set associative cache memory device having SDRAMs as a data memory includes means for locating all data which correspond to all blocks in the same set to the same row address of the DRAMS, accessing the row of the data memory before determining the cache hit in accessing the cache, executing the column access of the data memory with the block number that contains the accessed data if the access bits in the cache, accessing the column of the data memory with the block number that is replaced if the access misses in the cache and it is necessary to write the data in the block to be replaced back to the memory, and canceling the access of the column of the data memory if the access misses in the cache acid it is unnecessary to write the data in the block to be replaced back to the memory.

### OPERATION

In function, the cache memory device according to the invention is arranged to have a large volume, high level of associativity, and a short access latency as saving the pins of the LSI for being inputted with data.

The latency of the cache access is shortened by accessing the row of the data memory before determining whether the access hits or misses in the cache. By changing the column address when the access is determined whether hits or misses in the cache, either the data to be accessed or the data to be replaced may be read out. Hence, when the cache miss takes place, the precedent access to the row of the data memory bank becomes meaningful. Hence, a system having a cache memory with a high dirty rate (a probability that the data stored in the cache is different from the content saved in the main storage as a result of updating the data in the cache) will have a shorter access latency without lowering the efficiency of the data memory bank compared with the case that no precedent access to row takes place. If the block to be replaced is not required to be written back to the main storage, the precedent access to the row of the data memory bank is made wasteful, so that the busy time for the unnecessary bank appears. However, as described in the below-indicated embodiment, if the system provides two or more data memory banks, the influence of the wasted busy time of the banks that blocks the succeeding cache access to the same bank may be tolerated.

### BRIEF DESCRIPTION OF DRAWINGS

FIG. 1 is a diagram showing a computer system including a cache memory device according to an embodiment of the present invention;

FIG. 2 is a table listing a detail arrangement of an address selector;

FIG. 3 is a timing chart showing a process of a read operation to a data memory 15 of a bank 0;

FIG. 4 is a timing chart showing a process of a write operation to the data memory 15 of the bank 0;

FIG. 5 is a timing chart showing a process in accessing a row of the memory 15 of the bank 0 and cancelling access to a column thereof;

FIG. 6 is a view showing a detail arrangement of an address latch shown in FIG. 1;

FIG. 7 is a view showing a detail arrangement of an entry of a tag memory; and

FIG. 8 is a timing chart showing a process in reading the data memory 15 of the bank 0 when the load request from a processor 1 either hits in the cache or misses and the resulting write back is needed.

### BEST MODE FOR CARRYING OUT THE INVENTION

Hereafter, an embodiment of the present invention will be described in detail with reference to the appended drawings.

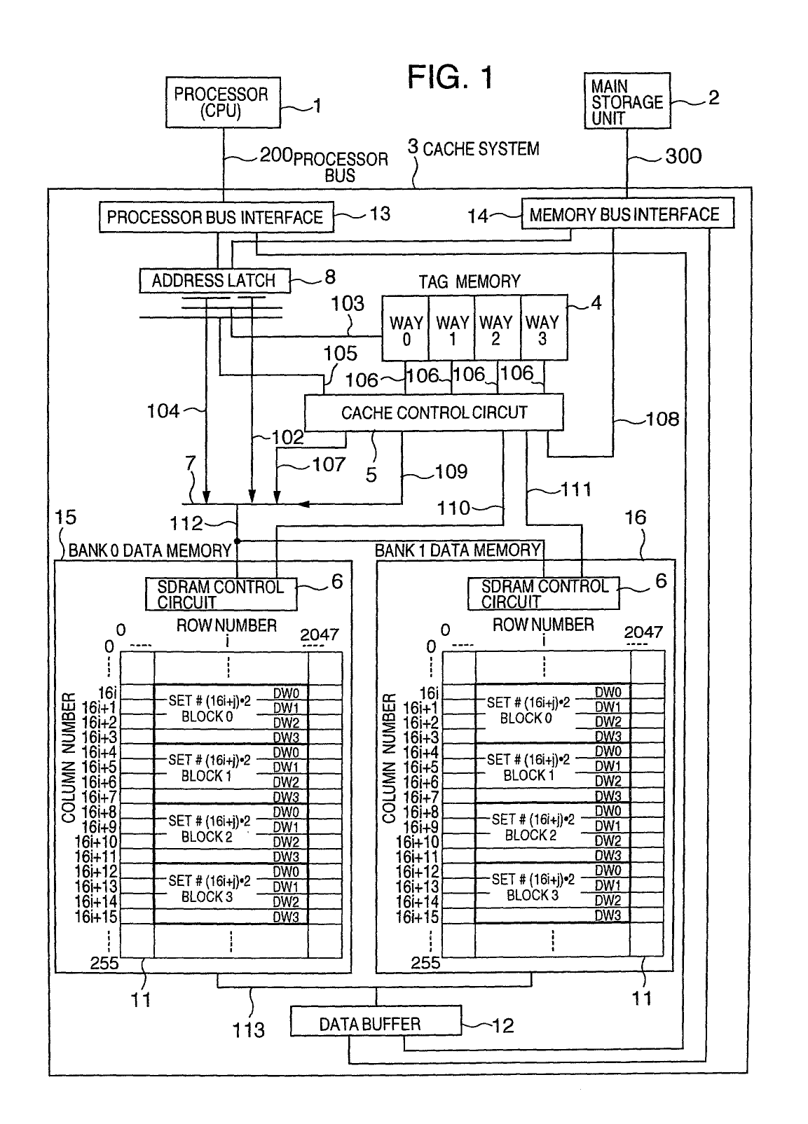

FIG. 1 is a diagram showing a computer system including a cache memory device according to an embodiment of the invention. In FIG. 1, a numeral 1 denotes a processor (CPU). A numeral 2 denotes a main storage unit. A numeral 3 denotes a cache system. A numeral 200 denotes a processor bus connecting between the processor 1 and the cache system 3. A numeral 300 denotes a memory bus connecting between the main storage unit 2 and the cache system 3. The cache system 3 includes a tag memory 4, a cache control circuit 5, an address selector 7, an address latch 8, a data buffer 12, a processor bus interface 13, a memory bus interface 14, a bank 0 data memory 15, and a bank 1 data memory 16. Further, each of the memories 15 and 16 includes an SDRAM control circuit 6 and a DRAM MAT (cell Matrix) 11.

In this embodiment, the cache has a volume of 16 MB, four way set associations and a line size (block size) of 64 bytes. The data memory is composed of two banks with 64-byte interleaved. Each DRAM MAT 11 consists of 2048 rows×256 columns×16 bytes. The volume of the main storage unit 2 is 2 G bytes. The data transfer unit between the processor 1 and the cache system 3 and between the cache system 3 and the main storage unit 2 is 64 bytes.

In the following, as specific terms, 16 bytes are defined as a double word (DW). Four double words of 64 bytes are defined as a double word 0, a double word 1, a double word 2, and a double word 3 in the ascending order of the double word address.

The processor 1 includes means for sending a load address to the processor bus 200 and requesting the cache system 3 to load the corresponding data from the main storage. Further, the processor 1 also includes means for sending a store address and store data onto the processor bus 200 and requesting the cache system 3 to store the data. The means for requesting the system 3 to load the data and the means for requesting the system 3 to store the data are not essential to the present invention. Hence, those means are not illustrated and described herein.

When the processor 1 issues a load request the processor bus interface 13 sets the load address to the address latch 8, sets the loaded data to the data buffer 12 and sends it to the processor 1 through the processor bus 200. Further, when the processor 1 issues a store request, the processor bus interface 13 sets the store address to the address latch 8, and sets the data to be stored to the data buffer 12.

The main storage unit 2 includes means for reading out the data from the memory by using the load address received through the memory bus 300 in response to the load request from the cache system 3 and sending the load data to the cache system 3 through the memory bus 300 together with the load address. The main storage unit 2 includes means for storing the data received through the memory bus 300 in the memory in response to the store request from the cache memory 3 by using the store address received through the memory bus 300.

The memory bus interface 14 sends the load address received from the cache control circuit 5 to the main storage unit 2 through the memory bus 300. When the load data and the load address are sent from the main storage unit 2, the memory bus interface 14 sets the load address to the address latch 8 and sets the load data to the data buffer 12.

Moreover, the memory bus interface 14 includes means (not shown) for sending the store address from the cache control circuit 5 and the store data from the data buffer 12 to the main storage unit 2 through the memory bus 300.

The bank 0 data memory 15 or the bank 1 data memory 16 is composed of a SDRAM (Synchronous DRAM) that operates at a fast rate in synchronous with the clocks from the outside. Later, the location of the data on the DRAM MAT 11 will be described.

An even set number is assigned to the bank 0 data memory 15, while an odd set number is assigned to the bank 1 data memory 16. In each bank, 16 double words belonging to four blocks of the same set are assigned to 16 consecutive column addresses of the same row address, respectively. At this time, four double words belonging to the same block are allocated to the serial column addresses. The double words are located in the ascending order of their addresses as the column address is increased in number.

The blocks in the same set may take any order. In this embodiment, however, the blocks are located in the ascending order of their numbers as the column address is increased in number.

As shown in FIG. 1, hence, the double words 0, 1, 2, 3 belonging to the way 0 of the set number (16i+j)×2 are assigned to the locations of the row number i and the column numbers 16j, 16j+1, 16j+2, and 16j+3 of the bank 0 data memory 15. Further, the double words 0 belonging to the ways 1, 2 and 3 of the set number (16j+j)×2 are assigned to the locations of the row number i and the column numbers 16j+4, 16j+8, and 16j+12 of the bank 0 data memory 15. In this embodiment, i is a natural number ranging from 0 to 2047 and j is a natural number ranging from 0 to 15.

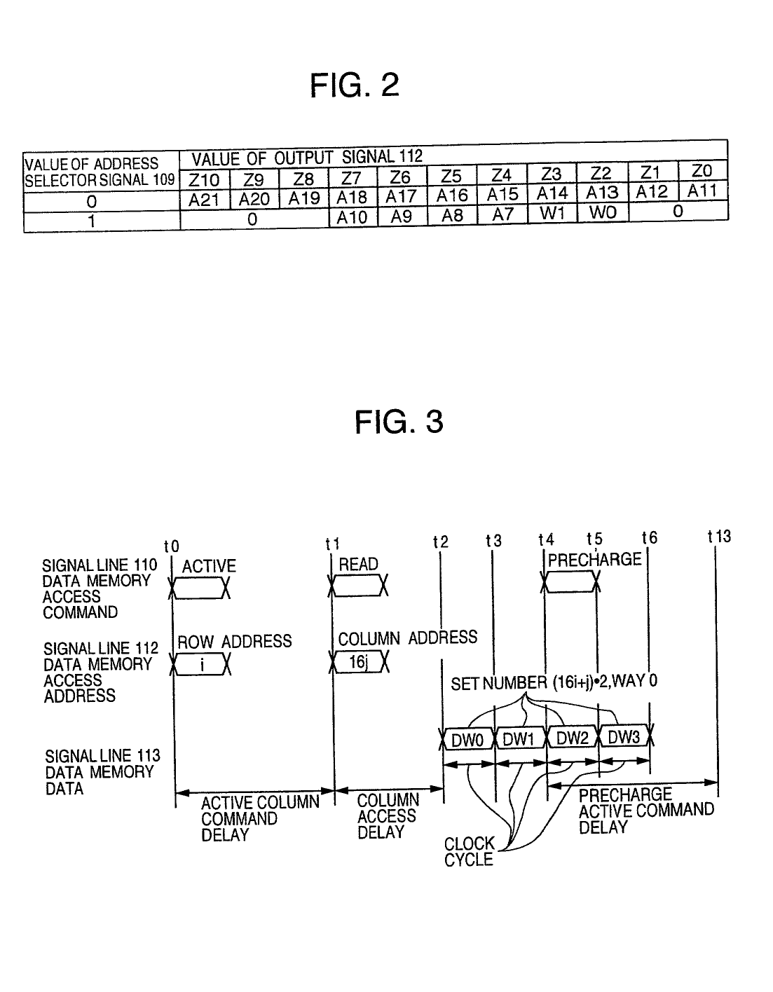

FIG. 2 shows a detail arrangement of the address selector 7.

The output signal 112 of the address selector 7 has a bit width of 11 bits, which are described in Z10 to Z9, respectively. Z10 is an MSB (Most Significant Bit) and Z0 is an LSB (Least Significant Bit). The address bits 21 to 7, which are sent from the address latch 8 through signal lines 104 and 102, are described as A21 to A7. Further, the way decode bits 1 and 0, which are sent from a cache control circuit through a signal line 107, are described as W1 and W0. If the value of the signal line 108 has a logical value of 1, the values A21 to A11 on the signal line 104 are outputted onto the signal line 112. If the value of the signal line 109 has a logical value of 0, Z10 to Z8 on the output signal line 112 output a logical value of 0. Z7 to Z4 output the values A10 to A7 on the signal line 102. Z3 to Z3 output the values W1 to W0 on the signal line 107. Z to Z0 output a logical value of 0.

The SRDRAM control circuit 6 has a function of accessing the row and the column of the DRAM MAT 11 by using the SDRAM access addresses sent from the address selector 7 through the signal line 112 in response to an SDRAM access command sent from the cache control circuit 5 through the signal lines 110 and 111. The SDRAM control circuit 6 operates in synchronous to the clocks given from the outside. Further, the SDRAM control circuit 6 has a function of holding a burst length which is set at the initialization and automatically incrementing a column address in the case of the column access. In this embodiment, the burst length is set to 4.

FIG. 3 shows a time chart showing the process in reading the bank 0 data memory 15.

At a time point t1, a read command is sent through the signal line 110 and the column address 16j is sent to the signal line 112. In response, the SDRAM control circuit 6 starts to read the values at the column numbers 16j, 16j+1, 16j+2, and 16j+3. The minimum time interval between the time points t0 and t1 is called an active command to column command delay.

The double words 0, 1, 2 and 3 belonging to the way 0 of the set number (16i+j)×2 are read onto the signal line 113 at the time points t2, t3, t4 and t5. The time interval between the time points t1 and t2 is called a column access delay. The time intervals between the time points 2 and t3, between the time points t3 and t4, between the time points t4 and t5, and between the time points t5 and t6 are the cycle times of the clocks given by the SDRAM control circuit 6. At the time point t6 or later, no data on the signal line 113 is guaranteed.

If the data access on the row number i is terminated, a precharge command is sent onto the signal line 113. Until the precharge command is sent, the column access to the data on the row number i can be executed. FIG. 3 shows the case that the data access on the row number i is terminated at the time point t6. In this embodiment, as the earliest time point, at t4, the precharge command may be issued.

After the precharge command is issued and the time interval called the precharge to active command period delay is passed, the active command may be issued. In FIG. 3, at the time point t13 or later, an active command may be sent onto the signal line 113.

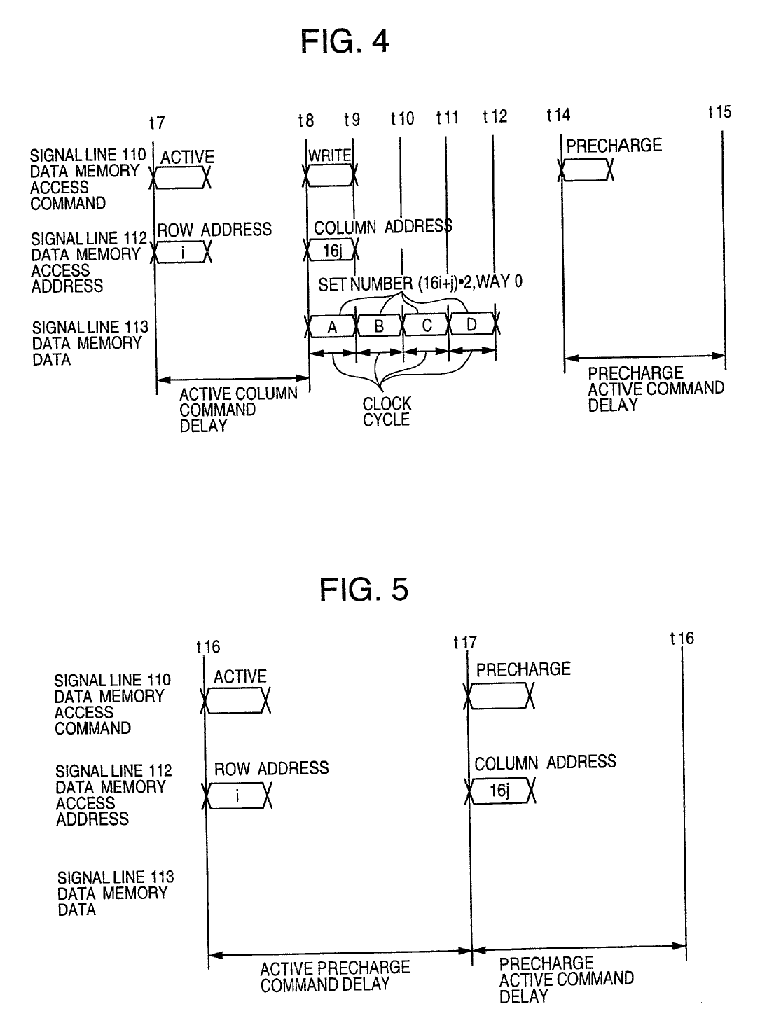

FIG. 4 shows the timing chart showing the process in writing the bank 0 data memory 15.

At the time point t7, the active command is sent through the signal line 110 and the row address i is sent through the signal line 112. In response, the SDRAM control circuit 6 starts to access the row number i.

At the time point t8, a write command is sent through the signal line 110 and a column address 16j is sent through the signal line 112. At the time points t8, t9, t10 and t11, the data A, B, C and D are sent through the signal line 113. In response, the SDRAM control circuit 6 starts to write the data A, B, C and D to the column numbers 16j, 16j+1, 16j+2 and 16j+3. The minimum time interval between the time points t7 and t8 is called an active command to column command delay. The time intervals between the time points t8 and t9, between the time points t9 and t10, between the time points t10 and t11 and between the time points t11 and t12 are the cycle times of the clocks given to the SDRAM control circuit 6.

If the data access on the row number i is terminated, the precharge command is sent onto the signal line 113. Until the precharge command is sent, the column access to the data on the row number i may be executed. FIG. 4 shows the case that the data access on the row number i is terminated at t12. In this embodiment, as the earliest time, at t14, the precharge command may be issued.

After the precharge command is issued and the time of the precharge active command delay is passed, the active command may be issued. In FIG. 4, at a time point t15 or later, the active command may be sent onto the signal line 13.

FIG. 5 is a timing chart showing a process in the row access to the bank 0 data memory 15 without doing the column access thereto.

At a time point t16, the active command is sent through the signal line 110 and the row address i sent through the signal line 112. In response, the SDRAM control circuit starts to access the data at the row number i.

As the earliest time, at a time point t17, the precharge command may be issued. The time interval between the time points t16 and t17 is called an active to precharge command period.

At a time point t18 or later, the active command may be sent onto the signal line 113. The time interval between the time points t17 and t18 is called a precharge to active command period.

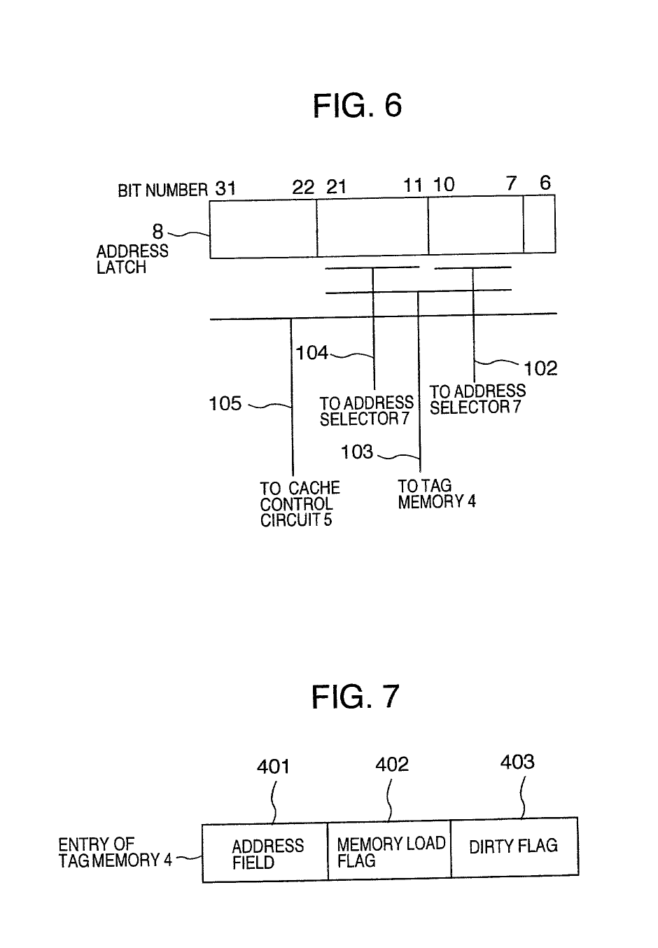

FIG. 6 shows a detail arrangement of the address latch 3.

The bit width of the address latch 3 is 26. The bit 6 is the least significant bit (LSB) and the bit 31 is the most significant bit (MSB).

The values of four bits from the bits 7 to 10 of the address latch are connected as the column address of the SDRAM to the address selector through signal line 102. The values of 16 bits from the bit 6 to the bit 12 of the address latch are connected as the set numbers to the tag memory 4 through the signal line 103. The values of 11 bits of the bits 11 to 21 of the address latch are conveyed as the row address of the SDRAM to the address selector 7 through the signal line 104. 26 bits of the bits 6 to 31 of the address latch are connected to the cache control circuit 5 through the signal line 105.

The tag memory 4 is composed of four ways and has entries of 64K. The value on the signal line 103 is used for specifying the access entry to the tag memory 4. The read data and the write data of the tag memory 4 are connected to the cache control circuit 5 through the signal line 106. The cache control circuit 5 has means for reading or writing the data from or in the tag memory 4.

FIG. 7 shows a detail arrangement of an entry of the tag memory 4.

A numeral 401 denotes an address field for holding 10 bits of the bit 31 to bit 22 of the address. A numeral 402 denotes a memory load flag for indicating that a load request the memory is being issued to the address indicated by this entry if the logical value is 1. A numeral 403 denotes a dirty flag for indicating that a store request is issued from the processor to the address indicated by this entry (the data in the memory is different from the value, which means [symbol] dirty [symbol] ) if the logical value is 1.

The cache control circuit 5 determines whether the access hits or misses in the cache and it determines the block to be replaced when a load request or a store request is sent from the processor 1 and when the load data is sent from the main storage unit 2.

Further, the cache control circuit 5 sets the address of the request to the address latch 8, when it receives the load request or the store request from the processor 1 or the load data from the main storage unit 2 and the bank of the data memory to be access is selected on the value of the address bit 6 sent through the signal line 105. Next, by using the values of the address bits 21 to 11 sent through the signal line 105, the cache control circuit 5 determines if the row access to the selected bank should be performed or not. In a case that the active command is issued to the same row numbers as the values of the address bits 21 to 11 in the selected bank and the precharge is not issued thereto (case 1), the cache control circuit 5 determines that the row access is not necessary. Except the case 1, the cache control circuit 5 determines that the row access is necessary. Then, the logical value 0 is sent onto the signal line 109 and the active command is sent onto any one of the signal lines 110 and 111 according to the selected bank number.

Detailed process of determining the cache hit is shown below.

The cache control circuit 5 determines whether the access hits or misses in the cache by using the values of the bits 31 to 22 of the address latch 8 sent through the signal line 105 and the read data of the tag memory 4 send through the signal line 106.

The logics of the determination are respective in when a load request or a store request is sent from the processor or when the load data is sent from the main storage unit 2.

1) When a load request or a store request is sent from the processor 1,

the values of the bits 31 to 22 of the address latch 8 sent through the signal line 105 are compared with the address field 401 of the read data of the tag memory 4 sent through the signal line 105 in each way. The compared result is ANDed with an inverted one of the value of the memory load flag 402 in each block. If a block has a logical value of 1 derived as the ANDed result, it indicates that the access hits in the cache. The way which contains the block specified as a hit way. If no block has a logical value of 1 derived as the ANDed result, it indicates that the access misses in the cache.

2) When the load data is sent from the main storage unit 2,

The values of the bits 31 to 22 of the address latch 8 sent through the signal line 105 are compared with the address field 401 of the read data of the tag memory 4 sent through the signal line 105 in each block. The compared result is ANDed with the value of the memory load flag 402 in each block. If a block has a logical value of 1derived as the ANDed result, it indicates that the access hits in the cache. The way which contains the block. If no block has a logical value of 1 derived as the ANDed result, it indicates that the access misses in the cache. In this embodiment, the block having a logical value of 1 in the memory load flag 402 will not be replaced. Hence, when the load data is sent from the main storage unit 2, the cache does not occur.

The detailed process for determining the block to be replaced.

The cache control circuit 5 determines the block to be replaced when the cache miss occurs. As a replacement policy random, and LRU policies are known. In this embodiment, the selection of policy is not significant. Therefore any proper policy may be employed here. As mentioned above, a system is employed in which the way having a logical value of 1 in the memory load flag 402 is not considered as a replace way. This system is not necessarily employed. When the dirty flag 403 in the block to be replaced has a logical value of 1, the write back is executed.

The cache control circuit 5 performs the following operations based on the results of the cache hit determination and the replace way determination as described above.

### Operation 1

When the cache hit occurs, the cache control circuit 5 encodes a hit way number into 2 bits as a way number to be accessed and sends the encoded number onto the signal line 107. When the cache miss occurs. The cache control circuit 5 encodes a way number which contains a block to be replaced into 2 bits as way number to be accessed and send the encoded number onto the signal line 107.

### Operation 2

When the load request from the processor misses in the cache, the values of the address bits 6 to 31 sent from the address latch 8 through the signal line 105 are sent onto the signal line 108 as load address to the memory. Further, when the write back is performed, the values of the address bits 6 to 21 sent from the address latch 8 through the signal line 105 are coupled with the values of the address field 401 of the block to be replaced and then sent onto the signal line 108 as the store address to the memory.

### Operation 3

When the cache hit occurs or the write back is performed, the logical value of 1 is outputted onto the signal line 109. Further, the column access command (read command or write command) is sent to the SDRAM control circuit of the bank 0 data memory 15 or the bank 1 data memory 16 through the signal line 110 or 111.

### Operation 4

When the load request from the processor 1 misses in the cache, the values of the bits 31 to 22 of the address latch 8 are written in the address field 401 of the block to be replaced in the tag member 4 and the logical value of 1 is written in the memory load flag 402 of the served block.

When the store request from the processor 1 misses, in the cache, the values of the bits 31 to 22 of the address latch 8 are written in the address filed 401 of the block to be replaced in the tag memory 4 and the logical value of 1 is written in the dirty flag 403 of the served block.

When the receiving load data from the main storage unit 2 hits in the cache, the logical value of 0 is written in the memory load flag 402 of the block to be replaced in the tag memory 4 and the logical value of 0 is written in the dirty flag 403 of the served block.

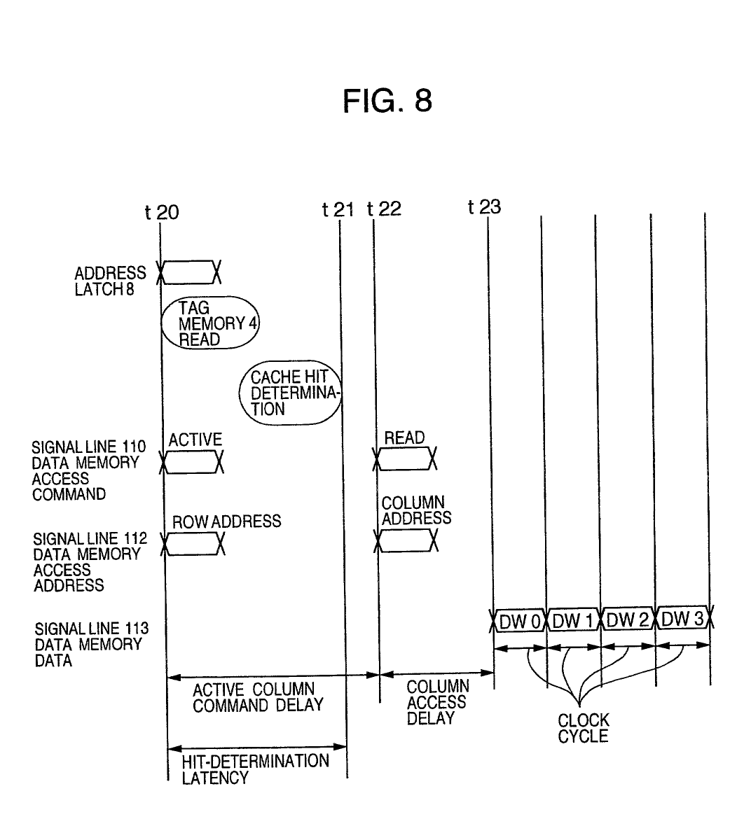

FIG. 8 is a timing chart showing a process in determining the cache hit or doing the write back for a load request from the processor 1. The load address is contained in the bank 0 data memory 15.

At a time point t20, the load address is set to the address latch 8. Concurrently with the read of the tag memory 4, the active command is sent to the bank 0 data memory. At a time point t21, the cache hit occurs. At a time point t22, the read command is sent to the bank 0 data memory 15. Though not illustrated in FIG. 8, the address sent to the bank 0 data memory 15 at the time point t22 is either the address of the hit way when the cache hit occurs or the address of the way to be replaced whether write back occurs. When the cache hit occurs, at the time point t23, the load data is outputted. When the write back occurs, at the time point t23, the data to be written to the main storage is outputted. The time interval between the times t22 and t23 is a column access delay. FIG. 8 shows the timing chart in which the time interval between the time points t22 and t23 (determination period) is smaller than the active column command delay. When the determination period is equal to the active to column command delay, the time point t21 is located on the time point t22.

As described above, by doing the row access to the data memory before determining whether the access hits or misses in the cache the latency of the cache access may be reduced. When the access turns out to be hit or miss, either to read the hit way or the way to be replaced is achieved only by changing the column address. Hence, even in the miss cache, the advanced row access to the data memory bank is not wasteful. In the system in which the cache memory has a high dirty rate (a probability that the data held in the cache is different from the content of the memory because of updating the cache), as compared with the case of applying the advanced row access, the access latency may be reduced without lowering the efficiency of the data memory bank.

In a case that the way to be replaced is not required to be written back when the cache miss takes place, the advanced row access to the data memory bank becomes wasteful, so that the busy time of the unnecessary bank appears. As mentioned in the foregoing embodiment, by providing plural data memory banks, the influence of the wasted bank busy time that blocks the succeeding cache access may be tolerated.

According to this embodiment, in the cache system arranged to use the SDRAM, the access determination may be efficiently overlapped with the data memory access.

As described above, the description has been expanded along the embodiment of the present invention. The present invention is not limited to the foregoing embodiment. It goes without saying that the invention may be modified in various forms without departing from the spirit of the invention.

For example, the foregoing embodiment has been arranged to have the SDRAM as a memory element of the data memory. In place, the memory element may be replaced with another memory element even if it may be accessed by the two steps of the row access and the column access for the general DRAM or the like. That is, if this type of memory element is used as the memory element of the data memory, in the cache access, it goes without saying that the access latency may be reduced by executing the row access before the determination and by executing the column access after determining the cache hit.

Further, in the description about the foregoing embodiment, the cache mounted on a processor chip (cache of the level 1) has not been mentioned. Normally, the cache memory is often composed of the level 1 cache housed in the processor chip and the level 2 cache composed of an outside memory chip such as the SDRAM indicated in the foregoing embodiment. In the computer system arranged as described above, it goes without saying that if the cache memory device of the invention may be applied to the level 2 cache, it is possible to reduce the access latency of the level 2 cache and thereby improve the overall performance of the 2 level cache memory. In addition, a level 3 cache may be located on the closer side of the main storage unit than the level 2 cache memory so that the present invention may be applied to this level 3 cache.

### INDUSTRIAL APPLICABILITY

The invention of the present application may be applied to the information processing apparatus provided with a hierarchical memory structure and a direct memory access (DMA) function, in particular, the information processing apparatus for guaranteeing coincidence between hierarchical memories (for example, a main memory and a cache memory) if a DMA process takes place by means of a snooping process. As a result, the information processing apparatus makes it possible to improve system performance by reducing the memory access time as guaranteeing coincidence between hierarchical memories at the DMA occurrence time.

1. A cache memory device including a data memory for storing data and a tag memory for storing an address of stored data in the data memory, comprising:
said data memory including a memory element to be accessed by two steps of a row access and a column access; and
said row access to said data memory being executed before determining whether the access hits or miss in the cache when doing a cache access.

2. The cache memory device as claimed in claim 1, wherein said column access is executed after fixing the cache hit determination when doing the cache access.

3. A set associative cache memory device, comprising:
a data memory for storing data, said data memory including a memory element to be accessed by two steps of a row access and a column access;
a tag memory for storing an address, said tag memory having plural blocks for the same set number of the index addresses thereof;
the data of all the blocks in the same set being located at the same row address of said data memory.

4. A cache memory device with plural associations, comprising:
a data memory for storing data, said data memory including a memory element to be accessed by two steps of a row access and a column access;
a tag memory for storing an address, said tag memory having plural ways for set numbers of index addresses thereof;
means for controlling a cache wherein the data of all the ways of the same set number is arranged at the same row address as said data memory; and
wherein said means for controlling the cache executes a row access to said data memory before fixing a cache hit determination when doing a cache access,
executes a column access of said data memory with the block number that contains the accessed data if the access hits in the cache,
executes a column access of said data memory with the block number that is replaced if the access misses in the cache and it is necessary to write the data in the block to be replaced back to the memory, and
cancels the column access to said data memory if the access misses in the cache and it is unnecessary to write the data in the block to be replaced back to the memory.

5. The cache memory device as claimed in claim 4, wherein said data memory is constituted of plural banks.

6. The cache memory device as claimed in claim 1, wherein said data memory is constituted of a DRAM.

7. The cache memory device as claimed in claim 1, wherein said data memory is constituted of a synchronous DRAM.

8. An information processing system having a processor, a main storage unit, a cache memory device for holding part of data to be stored in said main storage unit, a processor bus for connecting said processor with said cache memory device, and a memory bus for connecting said main storage unit with said cache memory device, comprising:
said processor having means for requesting data to be loaded onto said cache memory in said main storage unit through said processor bus and means for requesting data in said processor to be stored in said cache memory device through said processor bus;
said main storage unit having means for sending data in response to a load request from said cache memory device to said cache memory device through said memory bus and means for storing data in response to a store request from said cache memory device through said memory bus;
said cache memory device including a data memory for storing data and a tag memory for storing an address, said data memory including a memory element to be accessed by two steps of a row access and a column access, and the row access to said data memory being executed before fixing cache hit determination when doing the cache access.

9. The information processing system as claimed in claim 8, wherein when doing the cache access, the column access is executed after fixing the cache determination.

10. An information processing system having a processor, a main storage unit, a cache memory device for holding part of data to be stored in said main storage unit, a processor bus for connecting said processor with said cache memory device, and a memory bus for connecting said main storage unit with said cache memory device, comprising:
said processor having means for requesting data to be loaded onto said cache memory in said main storage unit through said processor bus and means for requesting data in said processor to be stored in said cache memory device through said processor bus;
said main storage unit having means for sending data in response to a load request from said cache memory device to said cache memory device through said memory bus and means for storing data in response to a store request from said cache memory device through said memory bus;
said cache memory device including a data memory for storing data, a tag memory for storing an address, and means for controlling a cache, said data memory being including a memory element to be accessed by two steps of a row access and a column access, and said cache memory being set associative with plural blocks for the same set numbers for index address of said tag memory;
the data of all the blocks in the same set being located at the same row address of said data memory; and
wherein said means for controlling the cache executes the row access of said data memory before fixing cache hit determination when doing the cache access,
executes the column access to said data memory with the block number that contains the accessed data if the access hits in the cache,
executes the column access to said data memory with the block number that is replaced if the access misses in the cache and it is necessary to write the data in the block to be replaced back to said main storage unit, and
cancels the column access to said data memory if it is unnecessary to write the data in the block to be replaced back to said main storage unit.

11. The information processing system as claimed in claim 8, wherein said data memory is constituted of a DRAM.

12. The information processing system as claimed in claim 10, wherein said data memory is constituted of a synchronous DRAM.
